(19) United States
(12) Patent Application Publication
(10) Pub. No.: US 2026/0083123 A1
(43) Pub. Date: Mar. 26, 2026

(54) COMPATIBLE POLYMER/INSECT REPELLENT COMPOSITION

(71) Applicant: The Government of the United States of America, as represented by the Secretary of the Navy, Arlington, VA (US)

(72) Inventors: Jeffrey G. Lundin, Burke, VA (US); Javier Jimenez, Washington, DC (US); Joseph A. Orlando, Billerica, MA (US); James E. Cilek, Jacksonville, FL (US)

(73) Assignee: The Government of the United States of America, as represented by the Secretary of the Navy, Arlington, VA (US)

(21) Appl. No.: 19/311,365

(22) Filed: Aug. 27, 2025

Related U.S. Application Data
(60) Provisional application No. 63/698,931, filed on Sep. 25, 2024.

(51) Int. Cl. A01N 35/06; A01N 25/10; A01P 17/00

(52) U.S. Cl. CPC A01N 35/06; A01N 25/10; A01P 17/00

(57) ABSTRACT

Disclosed herein is a composition having an insect repellent compound, a strengthening polymer, and a compatibilizing polymer. The strengthening polymer is immiscible in the insect repellent compound at a temperature from 23° C. to 250° C. The compatibilizing polymer is miscible in the insect repellent compound at the temperature. Insect repellant materials, including fibers and films, may be made from the composition.

### REFERENCE TO RELATED APPLICATIONS

This application claims the benefit of U.S. Provisional Application No. 63/698,931, filed on Sep. 25, 2024. The provisional application and all other publications and patent documents referred to throughout this nonprovisional application are incorporated herein by reference.

### TECHNICAL FIELD

The present disclosure is generally related to polymer and insect repellent compositions.

### DESCRIPTION OF THE RELATED ART

Outdoor personal protective strategies from biting arthropods have been dominated by dermal application of insect repellent and/or through fabric application of insecticide. Due to vaporization and dermal absorption, topical application of insect repellents have demonstrated efficacy times of no longer than 10 hours.[1,2] While insecticide-treated clothing are effective for long durations, the mechanism for protection is dependent on direct mosquito-insecticide contact, thus leaving untreated sites such as exposed skin absent of protection.[3-7] Therefore, frequent reapplication of topically applied repellents for protection of exposed skin often leads to noncompliance and have been subject to health hazards.[8,9]

Long-term insect-repelling devices have been long investigated with a special interest in repellent-loaded polymeric matrices.[10-23] Previous work highlighted the importance of chemical affinity between polymer and repellent in the development of repellent-loaded physical gels which demonstrated mosquito repulsion efficacies of longer than half a year.[14] While these gels show exceptional repellency times, the low mechanical properties of these materials alone are unsuitable for applications such high-performance fabrics (e.g., outerwear, tents, backpacks, etc.).

Previous attempts towards insect repellent-infused polymeric materials have included melting or dissolution of polymer systems loaded with insect repellent and subsequent processing to form a finished product with insect repellent properties. These materials have reported adequate repellency in the order of weeks. However, much of these polymer/insect repellent systems are immiscible with one another. As a result, phase separation between the insect repellent and the polymer system may occur. This potential for phase separation limits the maximum loading content of insect repellent due to concerns with weakened mechanical properties, uneven distribution of insect repellent, and increased spinning breakages. Such concerns are also present in other polymer processing techniques such as film casting and injection molding. Moreover, techniques that require polymer melting demand high temperatures that result in vaporization and subsequent loss of insect repellent through processing, especially if the polymer and insect repellent are immiscible with one another. This vaporization results in lower insect repellent concentrations within the finished product and can also lead to safety concerns if high concentration of insect repellent is vaporized through melt processing.

Most high-performance fabrics are constructed by nylon or nylon/cotton blends. Nylon filaments are manufactured by melt-spinning with varying processing temperature profiles dependent on the nylon type. Nonetheless, most melt processing temperatures exceed 200° C. which may vaporize additives such as insect repellents. The high processing temperatures can be avoided by alternative fiber spinning methods such as with solution spinning, however, nylon/insect repellent composites have only demonstrated mosquito repellency durations in the order of multi-days.[10,19] Hansen Solubility Parameters (HSPs) were used to quantify chemical affinity and suggested that the low efficacy times were a result of low chemical affinity between nylon and repellent.[11,14] Therefore, the addition of a compatibilizer in nylon/repellent composites may be critical for extended repellency.

Poly(lactic acid) (PLA) has been identified as a polymer potentially miscible with DEET and other insect repellents.[13,14,20-23]. Along with its biodegradability, PLA has relatively low melting temperatures compared to apparel-grade polymers with poly-D,L-lactic acid (PDLLA) and poly-L-lactic acid (PLLA) having melting points of around 130 and 150° C., respectively. These low temperatures can prevent the vaporization of additives such as insect repellents. However, PLA suffers from low rate of crystallization, brittleness, and small ductility which limits its use in high performance textiles. [24]

### SUMMARY OF THE INVENTION

Disclosed herein is a composition comprising: an insect repellent compound, a strengthening polymer that is immiscible in the insect repellent compound at a temperature from 23° C. to 250° C., and a compatibilizing polymer that is miscible in the insect repellent compound at the temperature.

Also disclosed herein is a method comprising: providing the above insect repellent compound, strengthening polymer, and compatibilizing polymer, and combining the insect repellent compound, the strengthening polymer, and the compatibilizing polymer to form a composition.

### BRIEF DESCRIPTION OF DRAWINGS

A more complete appreciation will be readily obtained by reference to the following Description of the Example Embodiments and the accompanying drawings.

FIGS. 1A-B show characterization of nootkatone-infused pellets through TGA/DTGA (FIG. 1A) and DSC (FIG. 1B).

FIG. 2A shows cross-sectional microscopy and FIG. 2B shows tensile testing of melt-spun nylon 12 and nylon 12/PDLLA yarn with varying nootkatone content.

FIG. 3A shows nootkatone-infused nylon 12 and nylon 12/PDLLA knits. FIG. 3B shows determination of nootkatone content in nootkatone-infused knits through isothermal TGA. FIG. 3C shows mean repellency lifespan of nootkatone-infused knits.

FIG. 4 shows a schematic differentiating macroscopic morphology and miscibility.

FIG. 5 shows DSC temperature sweeps of example immiscible, partially miscible, and completely miscible polymer/DEET systems.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a method for developing compatible polymer/insect repellent systems for melt extrusion processing and development of insect repelling devices. The purpose is to repel biting arthropods (e.g., mosquitos, ticks, fleas, flies, etc.) for multiple days or weeks. The material may be made in multiple forms such as fibers, films, patches, etc. as appropriate for the desired application. The system is composed of a linear or strengthening polymer, insect repellent, and compatibilizer polymer which leads to high retention of insect repellent through melt extrusion processes. Melt extrusion processes include filament spinning, film casting, and injection molding.

Murariu et al., 2023 melt processed nylon 12/PLLA blends and observed at nylon 12 or PLLA compositions of ≤20 wt % a spherical dispersal of the lower wt % polymer throughout the higher wt % polymer, similar to an emulsion. This polymer blend approach may offer potential to utilize the mechanical properties of nylon and the chemical affinity to insect repellent of PLA. As such, nylon 12/PDLLA blends were melt-processed with insect repellent for the development of filament and knits for mosquito bioassay. The retention of insect repellent was assessed through thermogravimetric analysis (TGA), and the compatibility of insect repellent in nylon 12/PDLLA blends were observed through differential scanning calorimetry (DSC). Nootkatone was selected as the target insect repellent due to its solid-state nature at room temperature for feasibility in melt processing.

The system represents the first example of incorporating compatibilizer polymer into insect repellent-embedded melt extrusion processes for enhanced retention of insect repellent within the finished product. Nylons are commonly utilized in manufacturing high-performance fabrics, thus was utilized in this study, however, alternative melt extrusion polymers (e.g., polyesters) can be utilized in this technology. The insect repellent utilized in this study is nootkatone, a naturally derived, solid insect repellent; however, alternative insect repellents (e.g., N,N-diethyl-meta-toluamide (DEET), permethrin, ethyl butylacetylaminopropionate) can be utilized in this technology. Poly-D,L-lactic acid demonstrates to be miscible with the insect repellents DEET and nootkatone at elevated temperatures, thus was utilized as a compatibilizer polymer in this study; however, alternative miscible polymer systems can be utilized in this technology. The melt extrusion method in this study is filament melt spinning, however, melt extrusion processes such as film casting and injection molding can also be utilized in this technology.

Miscible compatibilizer polymers were determined through Hansen Solubility Parameter modeling which characterizes chemical affinities through a tri-coordinate characterization method derived from a molecule's dispersion forces (δ_{D}), polar forces (δ_{P}), and hydrogen bonding forces (δ_{H}). This tri-coordinate parameter system can determine miscibility between a polymer and solvent system by calculating the distance between the select polymer and solvent system (Ra) through the following equation:

$${( Ra )}^{2} = 4 {( {δ}_{D 2} - {δ}_{D 1} )}^{2} + {( {δ}_{P 2} - {δ}_{P 1} )}^{2} + {( {δ}_{H 2} - {δ}_{H 1} )}^{2}$$

Miscibility between a solvent and polymer system is determined through the following equation:

$$RED = Ra / Ro$$

where Ro is the inherent interaction radius for a select polymer or copolymer. If Ra≤Ro (RED≤1), the solvent system will dissolve or swell the polymer. If Ra>Ro (RED>1), the solvent system will have no affinity to the polymer. The HSPs and resulting RED values between DEET and various polymers is shown in Table 1. RED is ≤1 for an array of polymers underscoring its miscibility with DEET. The HSPs of insect repellents are all share similar coordinates. Table 2 shows HSP data for PLA with various repellents, including nootkatone.

TABLE 1
HSPs of DEET and various polymers

| Material | δd | δp | δh | Ro | RED DEET |
|---|---|---|---|---|---|
| DEET | 18.1 | 7.1 | 3.6 | xxx | xxx |
| Polyurethane (PU) | 18.1 | 9.3 | 4.5 | 8.0 | 0.30 |
| Polyethyl- | 17.6 | 9.7 | 4.0 | 8.0 | 0.35 |
| methacrylate (PEMA) | | | | | |
| Polystyrene (PS) | 18.5 | 4.5 | 2.9 | 8.0 | 0.35 |
| Polyethylene | 18.2 | 6.4 | 6.6 | 8.0 | 0.44 |
| terephthalate (PET) | | | | | |
| Polycarbonate (PC) | 18.2 | 5.9 | 6.9 | 8.0 | 0.44 |
| Polylactic acid (PLA) | 18.5 | 8.0 | 7.0 | 8.0 | 0.45 |
| Polyvinylchloride (PVC) | 18.8 | 9.2 | 6.3 | 8.0 | 0.46 |
| Polymethyl- | 18.6 | 10.5 | 5.1 | 8.0 | 0.48 |
| methacrylate (PMMA) | | | | | |
| Polyethylene | 17.0 | 10.0 | 5.0 | 8.0 | 0.49 |
| oxide (PEO, PEG) | | | | | |
| CyclicOlefinCo- | 18.0 | 3.0 | 2.0 | 8.0 | 0.55 |
| polymer (COC) | | | | | |
| PDMS, Polysilicone | 17.2 | 3.0 | 3.0 | 8.0 | 0.56 |
| Polypropylene | 16.5 | 9.0 | 7.0 | 8.0 | 0.63 |
| oxide (PPO, PPG) | | | | | |
| Polyvinylacetate (PVA) | 17.6 | 2.2 | 4.0 | 8.0 | 0.63 |
| Polysulphone | 16.0 | 6.0 | 6.6 | 8.0 | 0.66 |
| Polycaprolactone | 17.7 | 5 | 8.4 | 8.0 | 0.66 |
| Polyethersulfone | 19.0 | 11.0 | 8.0 | 8.0 | 0.77 |
| Polyphenyleneoxide (PPO) | 17.9 | 3.1 | 8.5 | 8.0 | 0.79 |
| Epoxy | 17.4 | 10.5 | 9.0 | 8.0 | 0.82 |
| Polyoxymethylene (POM) | 17.2 | 9.2 | 9.8 | 8.0 | 0.85 |
| Polyethylene (LDPE) | 16.9 | 0.8 | 2.8 | 8.0 | 0.85 |
| P(AN-VC) 1:1 mol/mol | 20.9 | 11.9 | 4.4 | 8.0 | 0.93 |
| Polypropylene (PP) | 18.0 | 0.0 | 1.0 | 8.0 | 0.95 |
| Polyvinylidene | 17.0 | 12.1 | 10.2 | 8.0 | 1.07 |
| fluoride (PVDF) | | | | | |
| Polyvinylbutyral | 18.6 | 4.4 | 13.0 | 8.0 | 1.23 |
| Polyethylcyanoacrylate | 18.7 | 13.8 | 11.5 | 8.0 | 1.30 |
| Polyacrylic acid (PAA) | 19.9 | 7.0 | 14.3 | 8.0 | 1.41 |
| Nylon 66 | 17.4 | 9.9 | 14.6 | 8.0 | 1.43 |
| Polyacrylonitrile (PAN) | 22.4 | 14.1 | 9.1 | 8.0 | 1.55 |
| Polyvinylpyrrolidone (PVP) | 18.1 | 10.0 | 18.0 | 8.0 | 1.84 |
| Polyvinylalcohol (PVOH) | 15.0 | 17.2 | 17.8 | 8.0 | 2.31 |

TABLE 2
HSPs of PLA and various repellents

| Material | δd | δp | δh | RED PLA |
|---|---|---|---|---|
| Polylactic acid (PLA) | 18.5 | 8 | 7 | xxx |
| Icaridin | 17.3 | 8.9 | 6.8 | 0.32 |
| DEET | 18.1 | 7.1 | 3.6 | 0.45 |
| Benzyl benzoate | 20 | 5.1 | 5.2 | 0.57 |
| Cis,cis-nepetalactone | 17 | 5.2 | 4.6 | 0.59 |
| (2E)-3,7-dimethylocta-2,6-dienal | 16.9 | 4.7 | 4.1 | 0.68 |
| Dihydronepetalactone | 16.6 | 5.7 | 3.6 | 0.7 |
| Nootkatone | 17.6 | 4.2 | 2.6 | 0.76 |
| Citronellal | 16.5 | 4.5 | 3.9 | 0.77 |
| Permethrin | 17.8 | 2.8 | 2.5 | 0.88 |
| Transfluthrin | 16.5 | 3.7 | 2.8 | 0.9 |

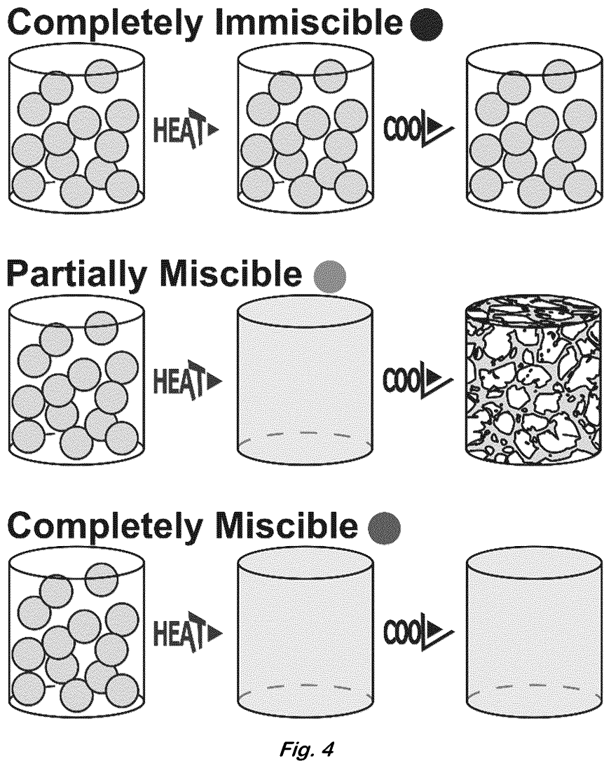

Polymer miscibility with DEET was conducted at a concentration of 5 g dL⁻¹ and under 130° C. with mechanical stirring for 3 hours followed by cooling at room temperature (˜23° C.) for 24 hours. Polymer/DEET miscibility tests were performed with respect to their RED values. PS, PVC, PMMA, PSU, PVP, P(S-AN), P(AN-VDC), and P(AN-VC) were determined to be miscible at elevated and room temperature. PET, LDPE, PP, PAA, PAN, and PVOH were immiscible at temperatures of 130° C.≥T≥23° C. PEG, PCL, and PVDF were miscible with DEET at elevated temperatures, however, underwent demixing upon cooling to room temperature. This temperature-dependent demixing is consistent with thermally-induced phase transition (TIPS) which generates heterogeneous polymer-rich and solvent-rich domains (FIG. 4). [3, 4] While sought-after for membrane formation, these phase-separated morphologies limit intermolecular chemical binding and physical entrapment between polymer and solvent which is subject to increased rates of solvent desorption.

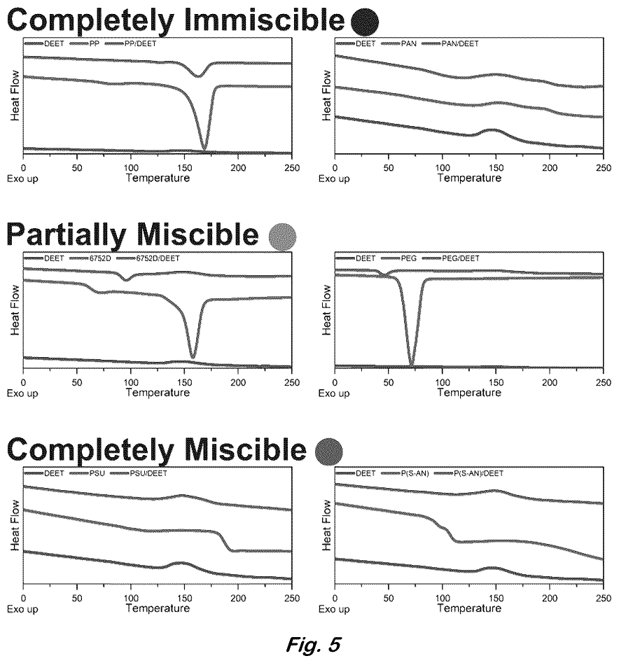

Correlative studies between HSP modeling and miscibility tests seem to demonstrate irregularities between theory and experimental results. At elevated temperatures, HSP modeling was 74% accurate in predicting miscibility and immiscibility between polymer and DEET. However, demixing upon cooling brings concerns into the validity of HSP modeling with only 58% of the polymer/DEET systems conforming to theoretical predictions. Interestingly, DSC temperature sweeps of partially miscible polymer systems exhibit a distinctly sharp melting peak (paracrystalline) whereas completely miscible polymer systems were void of a distinct melting peak (amorphous) (FIG. 5). These differences in polymer microstructure further suggest that polymer crystallization is inducing TIPS.

The composition affords a significant improvement in the amount of pesticide that can be retained within melt-extruded polymeric materials which can consequently prolong protection from biting arthropods. The addition of compatibilizer polymer can enhance the repellent retention by 14% throughout fabric manufacturing with the potential for further increasing the degree of pesticide retention. This decreased loss of repellent also offers decreased waste cost, increased efficacy, and safer working conditions throughout processing of consumer products such as apparel or accessories. Moreover, the chemical affinity of polymer and insect repellent is anticipated to prolong the repulsion efficacy due to extended diffusion times.

The disclosed composition comprises three components: 1) an insect repellent compound, 2) a strengthening polymer, and 3) a compatibilizing polymer. Insect repellents are known in the art and include, but are not limited to, nootkatone (shown below), N,N-diethyl-meta-toluamide (DEET), permethrin, and ethyl butylacetylaminopropionate.

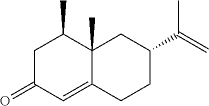 [SMILES: C=C(C)[C@@H]1CCC2=CC(=O)C[C@@H](C)[C@]2(C)C1]

The strengthening polymer is one chosen to be immiscible in the insect repellent compound at a temperature from 23° C. to 250° C. The immiscibility need only be at one temperature or a narrow range of temperatures, including room temperature. Methods of determining the miscibility of a repellent and a polymer are known in the art, including the HSP calculation described above. One example strengthening polymer suitable for use with nootkatone is nylon 12. Fibers of strengthening polymers in pure form may, for example, have a tensile strength of at least 20 MPa, and an elongation at break of no less than 1%.

The compatibilizing polymer is one chosen to be miscible in the insect repellent compound at at least one temperature where the strengthening polymer is immiscible with the repellent. One example compatibilizing polymer suitable for use with nootkatone and nylon 12 is poly(lactic acid), including poly-D,L-lactic acid (PDLLA).

The three components may be used in any proportions. It may be desirable to use proportions that results in a solid composition. Example ranges include, but are not limited to, 1-10 wt % of the insect repellent compound, 70-98 wt % of the strengthening polymer, and 1-20 wt % of the compatibilizing polymer. The composition may be formed into any desirable shape, such as by injection molding, spinning fibers, or casting films. Fibers may be incorporated into insect repellent garments, linings for tents or other outdoor furniture, or bed nets, for example.

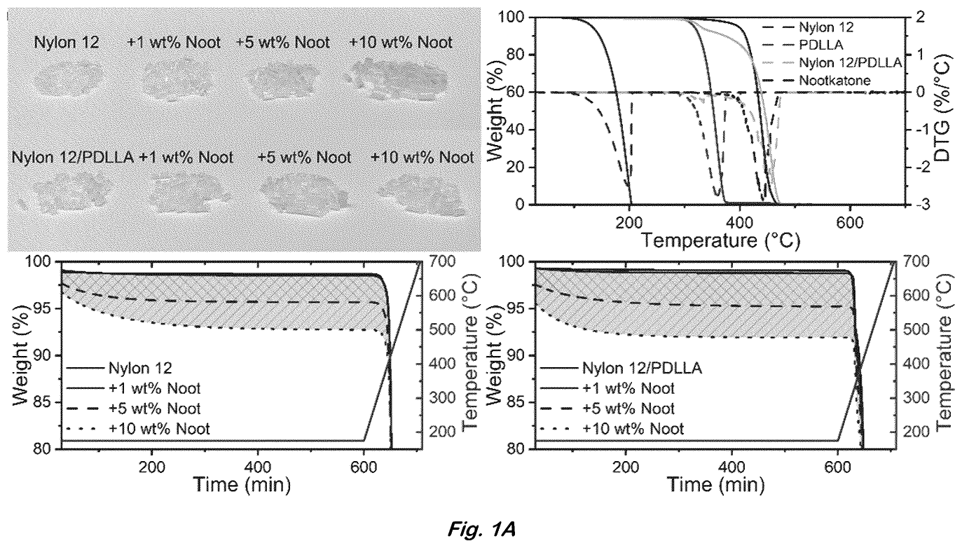

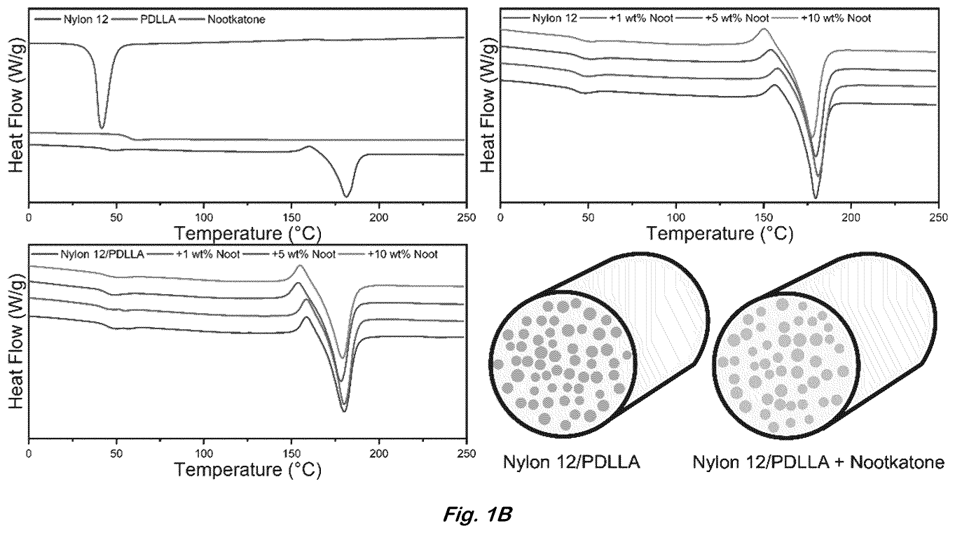

Nylon 12 (poly(dodecano-12-lactam)) and polylactic acid (PDLLA) (9/1 wt/wt) were compounded at temperatures 100-250° C., preferably 180-200° C. (described in detail below). Nootkatone at concentrations 0-100 wt %, preferably 1-10 wt % were incorporated into the nylon 12/PDLLA blends through compounding at temperatures 100-250° C., preferably 180-200° C. The resulting nootkatone-embedded nylon 12/PDLLA pellets retained 13 wt % more nootkatone throughout compounding and pelletization than with nootkatone-embedded nylon 12 pellets, as determined by thermogravimetric analysis (TGA) (FIG. 1A, Table 3). Differential scanning calorimetry (DSC) demonstrated minimal shifts in the respective melting and glass transition temperatures in nylon 12 and PDLLA blends, suggesting the polymers undergo liquid-liquid phase separation during the melt phase and solidify into separate domains (FIG. 1B). Upon the addition of nootkatone, the endothermic glass transition temperature/melting peak of PDLLA disappears whereas the nylon 12 shifts/peaks remain unchanged, suggesting that nootkatone is residing and interacting with the PDLLA domains.

TABLE 3
Nootkatone retention throughout compounding and pelletizing

| | | Theoretical | | |
|---|---|---|---|---|
| Polymeric | Nootkatone | Nootkatone | Nootkatone | Nootkatone |
| System | Loading (%) | Content (%) | Content (%) | Retention (%) |
| Nylon 12 | 0 | 0 | 0 | — |
| | 1 | 1.0 | 0.2 | 19% |
| | 5 | 4.8 | 3.1 | 65% |
| | 10 | 9.1 | 6.1 | 67% |
| Nylon | 0 | 0 | 0 | — |
| 12/PDLLA | 1 | 1.0 | 0.3 | 29% |
| | 5 | 4.8 | 3.9 | 82% |
| | 10 | 9.1 | 7.2 | 80% |

Multifilament melt spinning of these pellets demonstrated decreased processing temperatures with the inclusion of PDLLA as much as 20° C., reducing the potential for pesticide vaporization (Table 4).

TABLE 4
Optimized melt spinning parameters for nootkatone-
infused Nylon 12 and nylon 12/PDLLA pellets

| Polymeric | Nootkatone | Zone 1 | Zone 2 | Zone 3 | Zone 4 | Feed Rate | Take up |
|---|---|---|---|---|---|---|---|
| System | Loading (%) | (° C.) | (° C.) | (° C.) | (° C.) | (rpm) | (m/min) |
| Nylon 12 | 0 | 115 | 160 | 185 | 205 | 4 | 20 |
| | 1 | 150 | 180 | 210 | 215 | 4 | 20 |
| | 5 | 160 | 180 | 190 | 210 | 6 | 20 |
| | 10 | 160 | 180 | 190 | 210 | 6 | 20 |
| Nylon | 0 | 115 | 160 | 185 | 205 | 7 | 15 |
| 12/PDLLA | 1 | 115 | 180 | 185 | 205 | 6 | 15 |
| | 5 | 115 | 160 | 180 | 200 | 7 | 18 |
| | 10 | 115 | 160 | 180 | 190 | 7 | 20 |

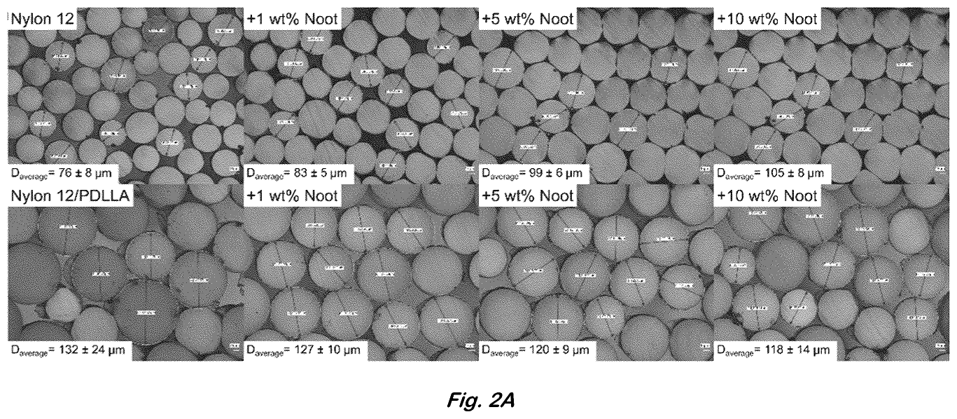

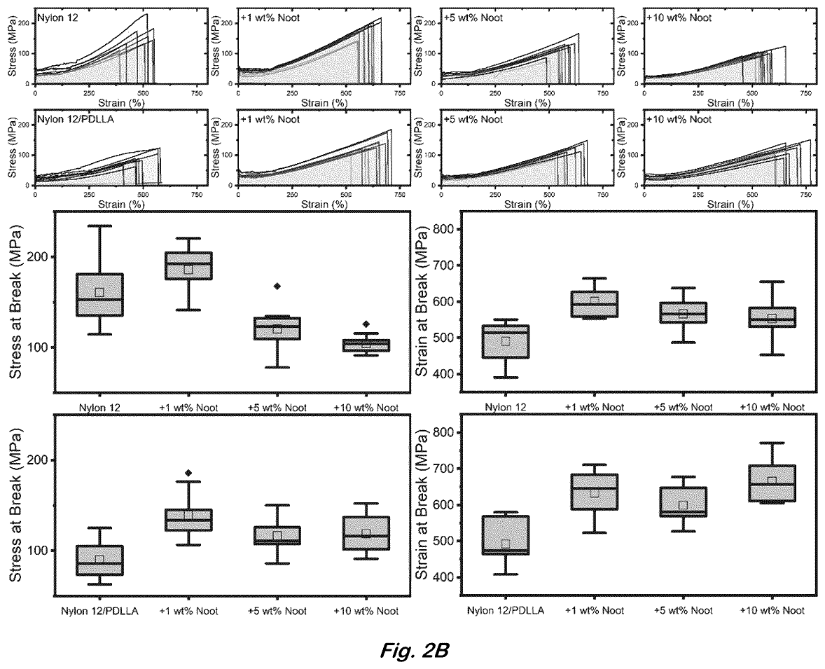

The mechanical properties of nootkatone-embedded nylon 12/PDLLA filaments remained the same for all nootkatone loading concentrations whereas a decrease in tensile stress (stress at break) with increasing nootkatone content was seen for nootkatone-embedded nylon 12 filaments (FIG. 2B). These results suggest that PDLLA behaves as a reservoir for nootkatone to prevent nootkatone's role as a defect within the nylon 12 matrix.

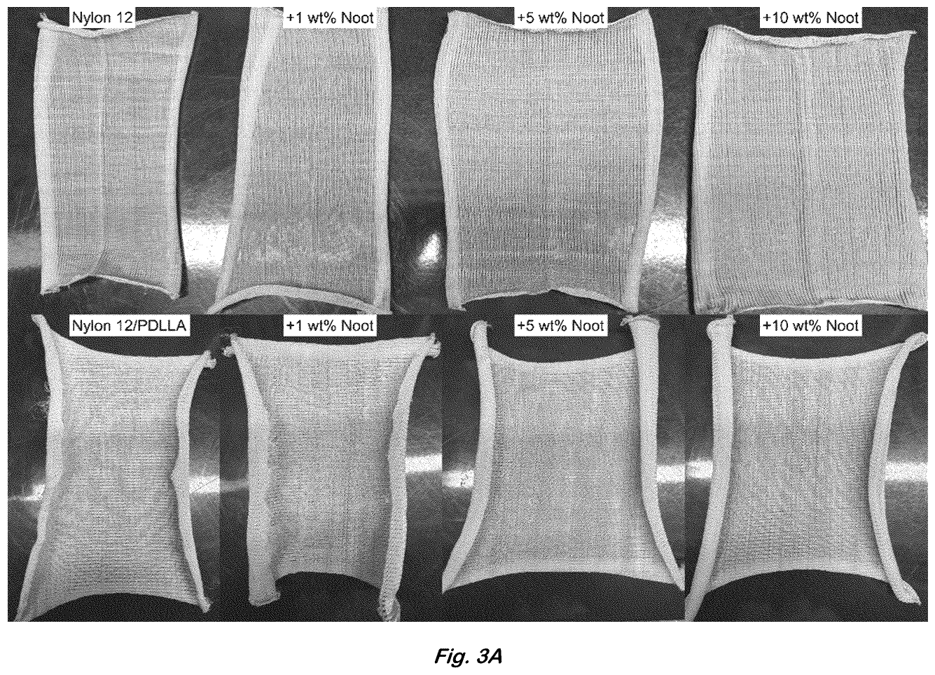

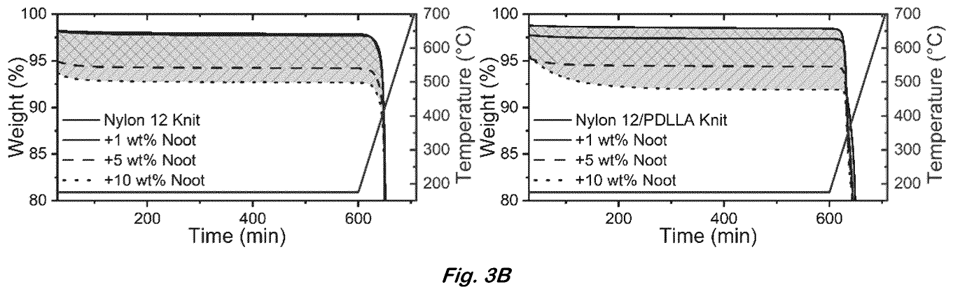

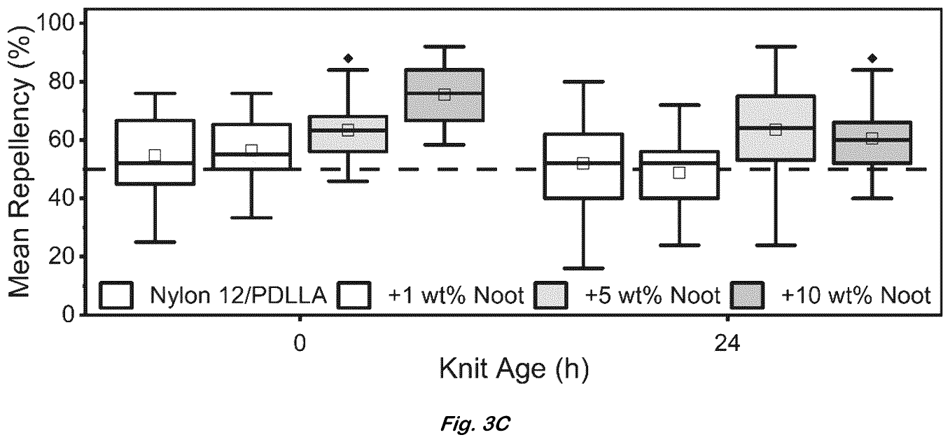

Nootkatone-embedded knits demonstrated significant moisture content as determined by TGA as indicated by nootkatone retention values being larger than the nootkatone content within the supplied pellets (FIG. 3A-B, Table 5). As the nootkatone loading increased, the values for nootkatone retention shifted towards more rational values for nootkatone content as the hydrophobic nature of nootkatone can limit the moisture regain of the polymeric matrix. Assuming moisture content is minimal for samples with 10 wt % nootkatone loading, the addition of PDLLA compatibilizer resulted in a 14% increase in nootkatone retention during fabric manufacturing.

TABLE 5
Nootkatone retention throughout compounding,
pelletizing, melt spinning, and knitting

| | Nootkatone | Theoretical | Nootkatone | Nootkatone |
|---|---|---|---|---|
| Polymeric | Loading | Nootkatone | Content | Retention |
| System | (%) | Content (%) | (%) | (%) |
| Nylon 12 | 0 | 0 | 0 | — |
| Knit | 1 | 1.0 | 0.2 | 18% |
| | 5 | 4.8 | 3.8 | 79% |
| | 10 | 9.1 | 5.3 | 59% |
| Nylon | 0 | 0 | 0 | — |
| 12/PDLLA | 1 | 1.0 | 1.1 | 113% |
| Knit | 5 | 4.8 | 4.1 | 87% |
| | 10 | 9.1 | 6.7 | 73% |

Mosquito bioassay of nootkatone embedded nylon 12/PDLLA demonstrated that the nylon 12/PDLLA +5 wt % and +10 wt % nootkatone exhibited 63 and 75% mean mosquito repellency, respectively, where a 50% repellency indicates normal, non-repellent, distributional behavior of mosquitoes around the testing midline (FIG. 3B). At 24 h, the repellency efficacy of nylon 12/PDLLA +10 wt % nootkatone decreased slightly, likely due to the behavioral variability in the population of mosquitos tested. Solid-state nootkatone undergoes sublimation as the mechanism for diffusion which consequently repels mosquitos. Typically, sublimation exhibits lower rates of diffusion than evaporation, which is the diffusion mechanism of liquid repellents. Additionally, due to its solid state, nootkatone residing within the filament cannot utilize capillary forces to diffuse through the polymer matrix, thus rely on sublimation to navigate through the polymer composite to the surface, which can also reduce the relative efficacy of the knits once nootkatone relegated on the surface sublimes. Methods to improve this moderate repellency can be through introducing liquid components miscible with nootkatone and PDLLA (e.g., liquid insect repellents) which can aid in 1) facilitating nootkatone diffusion throughout the polymer matrix by capillary forces and 2) enhancing desorption from the knit by evaporation.

The following examples are given to illustrate specific applications. These specific examples are not intended to limit the scope of the disclosure in this application.

Materials and methods—Nylon 12 (Sigma Aldrich, United States) and PDLLA (12% D-isomer content) (Ingeo Biopolymer 6060D, NatureWorks, United States) pellets were first dried in a 40° C. oven overnight prior to processing. Nylon and nylon 12/PDLLA (9/1 wt/wt) compounding was achieved with a Filabot EX6 Filament Extruder with zone 1-4 temperatures of 30, 180, 180, and 190° C., respectively. The extruding filament was first quenched with air via a Filabot Airpath and fed into a Filabot Pelletizer. Nootkatone (NootkaShield, Evolva, Switzerland) was incorporated in a separate compounding run at 1, 5, and 10 wt %. Multifilament melt-spinning was performed on a Xplore MC-40 with a 12-filament die and take up was performed with an Xplore Fiber Winder. The processing parameters were varied for optimal temperature and feed/take up conditions. Knitting of the as-spun yarn was performed on a LH-112B Fiber Analysis Knitter to manufacture 1-ply, 6-inch radius circular knits

Thermogravimetric analysis (TGA) was conducted on a TA Instruments Discovery TGA with platinum pans. The samples were under constant nitrogen purge at 40 mL min⁻¹. Heating ramps were conducted at 5° C. min⁻¹. Differential Scanning Calorimetry (DSC) was conducted on a TA Instruments Discovery DSC. Samples were loaded in 100 μL high-volume pans. Samples were first conditioned at −40° C. for 10 minutes, then underwent heating from −40 to 250° C. at 5° C. min⁻¹ under nitrogen. Tensile testing was performed on an Instron 343C-1 equipped with a 1 kN loadcell and pneumatic grips using samples with a gauge length of 40 mm and ramp rate of 96 mm min¹, in accordance with ASTM D3822.

Mosquito repellency of circular knits (3.5 cm) were evaluated using an adapted bioassay method that consisted of 3.8 cm diam by 30.5 cm clear glass cylinders placed at a 450 incline.[11,25,26] The knits were stored at −80° C. prior to testing and allowed to reach room temperature (approx. 22° C.) for at least 15 min but no more than 30 min at the start of the bioassay. The knits were fixed between 2 wire screen discs, secured into an open-ended translucent polyethylene cap (4.5 cm diameter×1.0 cm width; SF-16, Caplugs, Buffalo, NY), and placed at the top of each tube. Twenty-five non-blood-fed, five to seven-day-old, insecticide-susceptible female Ae. aegypti (ORL1952 strain) were mouth aspirated into each cylinder. Once mosquitoes were introduced into each tube, the end was capped with a screened disc of the same mesh size to prevent escape of mosquitoes and provide ventilation. Testing started at approximately 0700 with the location of mosquitoes in each tube recorded at 15 min, 30 min, lh, then hourly through 8h of continuous exposure. To determine residual effectiveness of treatments, single knits were evaluated again after 24 hours. Between these time intervals, all knits were stored in un-sealed, clear plastic polyethylene bags (separated by large and mini discs) at ambient room temperature in a windowless laboratory under a 12:12 light-dark fluorescent overhead lighting cycle where approximately 1700 to 0500 was unlit. Results are presented as the percent of mosquitos past the testing tube midline, termed as repellency.

Characterization of nootkatone-infused pellets—Nootkatone content was determined by TGA and DTG. Temperature ramps of nylon 12 and PDLLA displayed DTG peaks at 440 and 260° C. with weight loss onsets of around 350 and 275° C., respectively (FIG. 1A). Nootkatone exhibited DTG peaks at 200° C. with onset loss at around 100° C. A temperature of 175° C. was determined to provide significant vaporization of nootkatone with minimal nylon 12 and PDLLA degradation and weight loss. Isothermal TGA at 175° C. for 600 min showed increased nootkatone retention in nylon 12/PDLLA pellets compared to nylon 12 pellet processing (Table 1). In particular, nylon 12/PDLLA pellets loaded with 10 wt % nootkatone retained 80% of nootkatone compared to a 67% retention in nylon 12. Miscibility between nootkatone and PDLLA could facilitate intermolecular binding forces which aid in retaining nootkatone within the polymeric matrix, thus leading to increased retention throughout melt compounding and pelletizing.

The polymer microstructure of nylon 12 and nylon 12/PDLLA blends can be readily characterized through DSC (FIG. 1B). Nylon 12 shows glass transition temperatures (T_{g}) and melting (Tₘ) peaks at 45 and 182° C., respectively. Due to the amorphous nature of PDLLA, the T_{g} also behaves as the Tₘ which occurs at 57° C. Nootkatone demonstrates a sharp melting peak at 41° C. Nylon 12/PDLLA blends demonstrated slight overlap between the T_{g} of nylon 12 and the Tₘ of PDLLA. There were overall no significant temperature shifts in any characteristic peaks/transitions, indicative of phase separation between nylon 12 and PDLLA.

Affinity between nootkatone and polymer can be identified by shifts or removal of DSC peaks/transitions. Interestingly, nylon 12 incorporated with nootkatone is absent of the nootkatone melting peak at all nootkatone loading concentrations. However, there seemed to be no change in the DSC scan of nylon 12 loaded with nootkatone compared to pure nylon 12, suggesting minimal miscibility between nylon 12 and nootkatone. Nylon 12/PDLLA blends showed a loss of the PDLLA T_{g} with incorporation of ≥5 wt % nootkatone. This change in DSC suggests that nootkatone is residing within the PDLLA domains due to their miscibility.

Spinning, knitting, and mosquito bioassay of nootkatone-infused fabrics—Nootkatone-infused nylon 12 and nylon 12/PDLLA pellets underwent multifilament melt spinning with optimized parameters outlined in Table 3. The inclusion of PDLLA drastically decreased the processing temperatures for melt spinning nootkatone-infused filaments. Specifically, nylon 12/PDLLA pellets infused with 10 wt % nootkatone exhibited a 20° C. reduction in zone 4 (capillary exit) temperatures compared to solely nylon 12 while maintaining similar feed and take up speeds. As nootkatone can be more readily dispersed within the polymer matrix due to its miscibility with PDLLA, the overall viscosity of the melt is decreased by the solvated PDLLA/nootkatone complex, thus permitting for lower processing temperatures while maintaining similar feed and take up rates.

Filament cross-sections displayed excellent degrees of circularity amongst all samples (FIG. 2A). Voids near the filament edge were prevalent in nylon 12 filaments. These voids could be due to the vaporization of nootkatone or moisture throughout filament spinning. The diameter of nylon 12 filaments also increased with incorporation of nootkatone. Die swell is the relaxation of polymer chains into their random coil structure upon exiting the capillary, thus causing the polymer jet to swell. The die swell has been reported to increase with shear stress and entry pressure drop, and decrease with increased capillary aspect ratio (i.e., capillary length/diameter ratio), temperature, and jet stretch ratio (take up/feed ratio).[27,28] The increased filament diameter in nylon 12 filaments loaded with 5 and 10 wt % nootkatone was attributed to increased die swell that resulted from decreased jet stretch ratio. Interestingly, the inclusion of 1 wt % nootkatone in nylon 12 increased the filament diameter even though the jet stretch ratio was constant and the temperature increased, with the latter correlated to a decreased die swell. Since insect repellents and nylons exhibit a degree of immiscibility, the addition of nootkatone can behave as a nonsolvent to the nylon 12 melt which may increase both the viscosity and resulting shear of the overall melt, thus increasing the die swell and resulting filament diameters.

In contrast, nylon 12/PDLLA filaments demonstrated decreasing cross-sectional diameters with the addition of nootkatone. Nootkatone-induced PDLLA plasticization could have reduced the viscosity of the overall melt leading to increased jet stretch ratios, thus resulting in smaller die swell and decreased filament diameters. The standard deviation of the cross-sectional diameters in all nylon 12/PDLLA samples were larger than the nylon 12 samples. This deviation was attributed to insufficient compounding during nylon 12/PDLLA pellet processing which could lead to heterogeneous polymer pellets and resulting filaments.

Tensile testing of the filaments was performed to interrogate the impact of PDLLA and nootkatone within a predominately nylon 12 polymer matrix (FIG. 2B). The inclusion of PDLLA seemed to drastically reduce the tensile strength (stress at break) in nylon 12 filaments; however, the extensibility (strain at break) appears to be similar. Due to the filaments being as-spun, the high degree of isotropy permits significant strain as the polymer chains orient with extension (necking), thus possibly diluting the influence of PDLLA on strain at break within the nylon 12 matrix. However, the consequent strain hardening region is dependent on the oriented domains, and defects or contaminants can ultimately limit the stress at break.

Interestingly, the addition of 1 wt % nootkatone increased both the stress and strain at break in nylon 12 and nylon 12/PDLLA samples. The relatively small molecule nootkatone could act as a weak plasticizer to permit chain slippage which increases the degree of chain orientation throughout tensile testing. This increased orientation can subsequently enhance the strain at break of both nylon 12 and nylon 12/PDLLA samples. nylon 12 samples with >1 wt % nootkatone content demonstrated similar extensibility, but decreased tensile strength, underscoring the role of nootkatone as a weak plasticizer at low concentrations or a defect at higher concentrations. In contrast, nylon 12/PDLLA samples with increasing nootkatone content demonstrated similar tensile strength and slightly enhanced extensibility. The PDLLA domains can behave as a reservoir for excess nootkatone to prevent its role as a defect within the nylon 12 microstructure.

Nylon 12/PDLLA knits were more rigid and exhibited less drape than the nylon 12 knits (FIG. 3A). This increased rigidity could be due to the larger filament diameters in all nylon 12/PDLLA samples. Post-spin thermal drawing could aid in lowering the filament diameters for better drape and overall hand feel.

Nootkatone content in the knits was determined using the same method as with the pellets (FIG. 3B). Compared to the pellets, the nylon 12 knits seemed to contain similar nootkatone retention in 1 and 10 wt % loading samples (Table 4). Interestingly, 5 wt % loading samples seemed to gain nootkatone throughout melt spinning and knitting. Nylons are susceptible to high moisture contents with a maximum of around 10 wt %.[29] Moisture may have entered the polymer matrix and inflated the overall weight loss during TGA, making the nootkatone retention in the knits appear larger than in the pellets.

Nylon 12/PDLLA knits also demonstrated abnormally high nootkatone content with retention values of 113, 87, and 73% for 1, 5, and 10 wt % nootkatone, respectively. Interestingly, as nootkatone loading increased, the retention values shifted towards the values reported in the pellets. Nootkatone is a hydrophobic material, thus could possibly act as a barrier to moisture from entering the polymer matrix. PLA has also been reported to exhibit a much lower moisture content with a maximum of around 1 wt %, thus aiding in limiting the moisture content within the polymer composite.[29] Overall, the inclusion of PDLLA seems to aid in nootkatone retention within the nylon 12 matrix throughout the fabric manufacturing process due to its chemical affinity with nootkatone.

Mosquito bioassay was conducted on the knits at 0 and 24 h to assess the change in repellency over time (FIG. 3C). Initial assessment demonstrated that the nylon 12/PDLLA +5 wt % and +10 wt % nootkatone exhibited 63 and 75% mean mosquito repellency, respectively, where a 50% repellency indicates normal, non-repellent, distributional behavior of mosquitoes around the testing midline. At 24 h, the repellency efficacy of nylon 12/PDLLA +10 wt % nootkatone decreased slightly, likely due to the behavioral variability in the population of mosquitos tested. Solid-state nootkatone undergoes sublimation as the mechanism for diffusion which consequently repels mosquitos. Typically, sublimation exhibits lower rates of diffusion than evaporation, which is the diffusion mechanism of liquid repellents. As such, while nootkatone-infused nylon 12/PDLLA knits demonstrated significant mean repellencies, the solid-state nature of nootkatone resulted in lower efficacy than recently reported liquid insect repellent-based gels.[14] Additionally, due to its solid state, nootkatone residing within the filament cannot utilize capillary forces to diffuse through the polymer matrix, thus rely on sublimation to navigate through the polymer composite to the surface, which can also reduce the relative efficacy of the knits once nootkatone relegated on the surface sublimes. Methods to improve this moderate repellency can be through introducing liquid components miscible with nootkatone and PDLLA (e.g., liquid insect repellents) which can aid in 1) facilitating nootkatone diffusion throughout the polymer matrix by capillary forces and 2) enhancing desorption from the knit by evaporation.

In this work, the chemical affinity between PDLLA and nootkatone was utilized to increase the nootkatone retention throughout nylon 12 fabric manufacturing processes. Isothermal TGA demonstrated to be a rapid method to determine substrate content within a polymer matrix by determining the optimal temperature for vaporization of a single material. Through this methodology, a PDLLA content of 10 wt % demonstrated to increase nootkatone retention as much as 14 wt % throughout fabric manufacturing processes compared to without PDLLA. DSC confirmed that the increased nootkatone retention that was attributed to the chemical affinity between PDLLA and nootkatone, which hinders nootkatone vaporization and loss from the polymer composite. While the filament tensile properties weakened with the inclusion of PDLLA, post-spin thermal drawing can be performed to further improve the mechanical properties suitable for the intended application. Furthermore, while the inclusion of high concentrations of nootkatone lowered the tensile strength for nylon 12, nylon 12/PDLLA exhibited similar tensile properties with the inclusion of both low and high nootkatone content. This tensile independence suggests that PDLLA behaves as a reservoir for excess nootkatone to prevent its role as a defect within the nylon 12 microstructure. Therefore, the results of this study present a method to enhance substrate retention throughout fabric manufacturing processes by adding a small amount of compatibilizer polymer.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

### REFERENCES

1. Katz, T. M.; Miller, J. H.; Hebert, A. A. Insect repellents: historical perspectives and new developments. J Am Acad Dermatol 2008, 58, 865-871, doi:10.1016/j.jaad.2007.10.005.
2. Lupi, E.; Hatz, C.; Schlagenhauf, P. The efficacy of repellents against Aedes, Anopheles, Culex and Ixodes spp.—A literature review. Travel Medicine and Infectious Disease 2013, 11, 374-411, doi:https://doi.org/10.1016/j.tmaid.2013.10.005.
3. Orsborne, J.; DeRaedt Banks, S.; Hendy, A.; Gezan, S. A.; Kaur, H.; Wilder-Smith, A.; Lindsay, S. W.; Logan, J. G. Personal Protection of Permethrin-Treated Clothing against Aedes aegypti, the Vector of Dengue and Zika Virus, in the Laboratory. PLOS ONE 2016, 11, e0152805, doi:10.1371/journal.pone.0152805.
4. Pennetier, C.; Chabi, J.; Martin, T.; Chandre, F.; Rogier, C.; Hougard, J.-M.; Pages, F. New protective battle-dress impregnated against mosquito vector bites. Parasites & Vectors 2010, 3, 81, doi:10.1186/1756-3305-3-81.
5. Frances, S. P.; Watson, K.; Constable, B. G. Comparative toxicity of permethrin- and bifenthrin-treated cloth fabric for Anopheles farauti and Aedes aegypti. J Am Mosq Control Assoc 2003, 19, 275-278.
6. Sholdt, L. L.; Schreck, C. E.; Mwangelwa, M. I.; Nondo, J.; Siachinji, V. J. Evaluations of permethrin-impregnated clothing and three topical repellent formulations of deet against tsetse flies in Zambia. Medical and Veterinary Entomology 1989, 3, 153-158, doi:https://doi.org/10.1111/j.1365-2915.1989.tb00493.x.
7. Vaughn, M. F.; Funkhouser, S. W.; Lin, F.-C.; Fine, J.; Juliano, J. J.; Apperson, C. S.; Meshnick, S. R. Long-lasting Permethrin Impregnated Uniforms: A Randomized-Controlled Trial for Tick Bite Prevention. American Journal of Preventive Medicine 2014, 46, 473-480, doi:https://doi.org/10.1016/j.amepre.2014.01.008.
8. Schofield, S.; Crane, F.; Tepper, M. Good Interventions That Few Use: Uptake of Insect Bite Precautions in a Group of Canadian Forces Personnel Deployed to Kabul, Afghanistan. Military Medicine 2012, 177, 209-215, doi:10.7205/milmed-d-11-00205.
9. Chen-Hussey, V.; Behrens, R.; Logan, J. G. Assessment of methods used to determine the safety of the topical insect repellent N,N-diethyl-m-toluamide (DEET). Parasites & Vectors 2014, 7, 173, doi:10.1186/1756-3305-7-173.
10. Ryan, J. J.; Casalini, R.; Orlicki, J. A.; Lundin, J. G. Controlled release of the insect repellent picaridin from electrospun nylon-6,6 nanofibers. Polymers for Advanced Technologies 2020, 31, 3039-3047, doi:10.1002/pat.5028.
11. Fulton, A. C.; Thum, M. D.; Jimenez, J.; Camarella, G.; Cilek, J. E.; Lundin, J. G. Long-Term Insect Repellent Electrospun Microfibers from Recycled Poly(ethylene terephthalate). Acs Appl Mater Inter 2023, doi:10.1021/acsami.3c08912.
12. Tavares, M.; da Silva, M. R. M.; de Oliveira de Siqueira, L. B.; Rodrigues, R. A. S.; Bodjolle-d'Almeida, L.; dos Santos, E. P.; Ricci-Júnior, E. Trends in insect repellent formulations: A review. International Journal of Pharmaceutics 2018, 539, 190-209, doi:https://doi.org/10.1016/j.ijpharm.2018.01.046.
13. Du, F.; Bonadies, I.; Longo, A.; Rupp, H.; Di Lorenzo, M. L.; Androsch, R. Sustainable Electrospun Poly(l-lactic acid) Fibers for Controlled Release of the Mosquito-Repellent Ethyl Butylacetylaminopropionate (IR3535). ACS Applied Polymer Materials 2023, 5, 4838-4848, doi:10.1021/acsapm.3c00462.
14. Jimenez, J.; Cilek, J.; Schluep, S.; Lundin, J. G. Designing Thermoreversible Gels for Extended Release of Mosquito Repellent. Journal of Materials Chemistry B 2024, doi:10.1039/D4TB01384K.
15. Sibanda, M.; Focke, W.; Braack, L.; Leuteritz, A.; BrUnig, H.; Tran, N. H. A.; Wieczorek, F.; Trümper, W. Bicomponent fibres for controlled release of volatile mosquito repellents. Materials Science and Engineering: C 2018, 91, 754-761, doi:https://doi.org/10.1016/j.msec.2018.06.016.
16. Mapossa, A. B.; Focke, W. W.; Tewo, R. K.; Androsch, R.; Kruger, T. Mosquito-repellent controlled-release formulations for fighting infectious diseases. Malar J 2021, 20, 165, doi:10.1186/s12936-021-03681-7.
17. Muñoz, V.; Buffa, F.; Molinari, F.; Hermida, L. G.; García, J. J.; Abraham, G. A. Electrospun ethylcellulose-based nanofibrous mats with insect-repellent activity. Materials Letters 2019, 253, 289-292, doi:https://doi.org/10.1016/j.matlet.2019.06.091.
18. Misni, N.; Nor, Z. M.; Ahmad, R. Repellent effect of microencapsulated essential oil in lotion formulation against mosquito bites. Journal of Vector Borne Diseases 2017, 54.
19. Thum, M. D.; Weise, N. K.; Casalini, R.; Fulton, A. C.; Purdy, A. P.; Lundin, J. G. Incorporation of N,N,-diethyl-meta-toluamide within electrospun nylon-6/6 nanofibers. Journal of Applied Polymer Science 2022, 139, e53237, doi:https://doi.org/10.1002/app.53237.
20. Bonadies, I.; Longo, A.; Androsch, R.; Jehnichen, D.; Gobel, M.; Di Lorenzo, M. L. Biodegradable electrospun PLLA fibers containing the mosquito-repellent DEET. European Polymer Journal 2019, 113, 377-384, doi:10.1016/j.eurpolymj.2019.02.001.
21. Di Lorenzo, M. L.; Longo, A. N,N-Diethyl-3-methylbenzamide (DEET): A mosquito repellent as functional plasticizer for poly(l-lactic acid). Thermochim Acta 2019, 677, 180-185, doi:https://doi.org/10.1016/j.tca.2019.02.004.
22. Mapossa, A. B.; López-Beceiro, J.; Díaz-Díaz, A. M.; Artiaga, R.; Moyo, D. S.; Mphateng, T. N.; Focke, W. W. Properties of Mosquito Repellent-Plasticized Poly(lactic acid) Strands. Molecules 2021, 26, doi:10.3390/molecules26195890.
23. Ferreira, I.; Brünig, H.; Focke, W.; Boldt, R.; Androsch, R.; Leuteritz, A. Melt-Spun Poly(D,L-lactic acid) Monofilaments Containing N,N-Diethyl-3-methylbenzamide as Mosquito Repellent. Materials 2021, 14, doi:10.3390/ma14030638.
24. Murariu, M.; Arzoumanian, T.; Paint, Y.; Murariu, O.; Raquez, J.-M.; Dubois, P. Engineered polylactide (PLA)-polyamide (PA) blends for durable applications: 1. PLA with high crystallization ability to tune up the properties of PLA/PA12 blends. European Journal of Materials 2023, 3, 1-36, doi:10.1080/26889277.2022.2113986.
25. Jiang, S.; Yang, L.; Bloomquist, J. R. High-throughput screening method for evaluating spatial repellency and vapour toxicity to mosquitoes. Medical and Veterinary Entomology 2019, 33, 388-396, doi:https://doi.org/10.1111/mve.12377.
26. Owusu, H. F.; Müller, P. How important is the angle of tilt in the WHO cone bioassay? Malaria Journal 2016, 15, 243, doi:10.1186/s12936-016-1303-9.
27. Liang, J.-Z. The elastic behaviour during capillary extrusion of LDPE/LLDPE blend melts. Polymer Testing 2002, 21, 69-74, doi:https://doi.org/10.1016/S0142-9418(01)00050-2.
28. Ji, B.-H.; Wang, C.-G.; Wang, Y.-X. Effect of jet stretch on polyacrylonitrile as-spun fiber formation. Journal of Applied Polymer Science 2007, 103, 3348-3352, doi:https://doi.org/10.1002/app.25490.
29. Banjo, A. D.; Agrawal, V.; Auad, M. L.; Celestine, A.-D. N. Moisture-induced changes in the mechanical behavior of 3D printed polymers. Composites Part C: Open Access 2022, 7, 100243, doi:https://doi.org/10.1016/j.jcomc.2022.100243.

What is claimed is:

1. A composition comprising:
an insect repellent compound;
a strengthening polymer that is immiscible in the insect repellent compound at a temperature from 23° C. to 250° C.; and
a compatibilizing polymer that is miscible in the insect repellent compound at the temperature.

2. The composition of claim 1, wherein the insect repellent compound is nootkatone.

3. The composition of claim 1, wherein the strengthening polymer is nylon 12.

4. The composition of claim 1, wherein the compatibilizing polymer is poly(lactic acid).

5. The composition of claim 1, wherein the composition comprises 1-10 wt % of the insect repellent compound.

6. The composition of claim 1, wherein the composition composes 70-98 wt % of the strengthening polymer.

7. The composition of claim 1, wherein the composition composes 1-20 wt % of the compatibilizing polymer.

8. The composition of claim 1, wherein the composition is in the form of a filament.

9. A garment comprising the filament of claim 8.

10. The composition of claim 1, wherein the composition is in the form of a film.

11. A method comprising:
providing an insect repellent compound;
providing a strengthening polymer that is immiscible in the insect repellent compound at a temperature from 23° C. to 250° C.;
providing a compatibilizing polymer that is miscible in the insect repellent compound at the temperature;
combining the insect repellent compound, the strengthening polymer, and the compatibilizing polymer to form a composition.

12. The method of claim 11, wherein the insect repellent compound is nootkatone.

13. The method of claim 11, wherein the strengthening polymer is nylon 12.

14. The method of claim 11, wherein the compatibilizing polymer is poly(lactic acid).

15. The method of claim 11, wherein the composition comprises 1-10 wt % of the insect repellent compound.

16. The method of claim 11, wherein the composition composes 70-98 wt % of the strengthening polymer.

17. The method of claim 11, wherein the composition comprises 1-20 wt % of the compatibilizing polymer.

18. The method of claim 11, further comprising:
forming a filament or a film of the composition.
